(19) United States
(12) Patent Application Publication
(10) Pub. No.: US 2023/0192450 A1
(43) Pub. Date: Jun. 22, 2023

(54) DEVICE FOR ROTATING UTILITY POLE AND METHOD FOR CONTROLLING POSITION

(71) Applicant: NIPPON TELEGRAPH AND TELEPHONE CORPORATION, Tokyo (JP)

(72) Inventors: Tatsuya MOKI, Musashino-shi, Tokyo (JP); Takashi EBINE, Musashino-shi, Tokyo (JP); Hidenobu HIROTA, Musashino-shi, Tokyo (JP); Yoshiyasu SATO, Musashino-shi, Tokyo (JP)

(73) Assignee: NIPPON TELEGRAPH AND TELEPHONE CORPORATION, Tokyo (JP)

(21) Appl. No.: 17/926,697

(22) PCT Filed: May 25, 2020
(86) PCT No.: PCT/JP2020/020500

§ 371 Date: Nov. 21, 2022

(51) Int. Cl. B66C 1/28; B66C 1/44; B66C 1/68; B66C 13/46

(52) U.S. Cl. CPC B66C 1/28; B66C 1/44; B66C 1/68; B66C 13/46; B66C 2700/0357

(57) ABSTRACT

An object of the present disclosure is to provide a utility pole rotation apparatus and a position control method that can reduce not only the number of workers for adjusting an orientation of a scaffold bolt (an orientation of a side surface of the utility pole) but also the number of workers for stopping swinging of the utility pole, which cannot be simultaneously reduced in the related art.

The utility pole rotation apparatus according to the present disclosure includes a gripping portion that grips a utility pole, and a roller having a cylindrical shape that contacts the utility pole at an inner side of the gripping portion and rotates the utility pole with a longitudinal direction serving as an axis due to rotation of the roller.

### TECHNICAL FIELD

The present invention relates to an apparatus and a method for rotating a utility pole while gripping the utility pole.

### BACKGROUND ART

A utility pole installed outdoors is used in a form of supporting a communication cable for a communication company, and is used in a form of supporting a power transmission or power distribution cable for an electric power company.

In a form of usage of a utility pole, the utility pole is erected, and a cable and the like are attached to the utility pole. A method for erecting the utility pole is illustrated in FIGS. 1 to 3. A hole 110 is dug in a ground 105 by using a crane vehicle 100 as illustrated in FIG. 1. Then, as illustrated in FIG. 2, a utility pole 121 is lifted with a crane of the crane vehicle 100. Finally, as illustrated in FIG. 3, backfilling is performed in which the utility pole 121 is put into the hole 110. In the construction of erecting the utility pole 121, lifting, moving, and erecting the utility pole 121 by using the crane vehicle 100 are commonly executed.

A structure of the utility pole is known to have a cylindrical shape, and when the utility pole is lifted with the crane, the utility pole naturally swings. The utility pole is configured of concrete and iron, and thus, its weight is heavy. As illustrated in FIG. 2, when the utility pole 121 having a cylindrical shape and heavy weight is lifted with the crane at the center in a longitudinal direction of the utility pole 121, it is easy to imagine that the utility pole 121 will swing. The utility pole 121 having heavy weight swings, and for example, when a person passes near there and the utility pole hits the person, the person is seriously injured. Thus, workers hold an end of the utility pole 121, the workers are arranged so that the utility pole 121 does not swing, and further, a guide worker 202 is arranged in order to protect pedestrians or the like.

As described above, when the utility pole 121 is lifted with the crane, the number of workers is large in order to erect the utility pole 121, because the utility pole 121 swings and the workers for stopping swinging and the guide worker 202 are required.

Thus, a heavy machine that can reduce the number of workers has been proposed (Patent Literature (PTL) 1). A point of PTL 1 is illustrated in FIG. 4. The use of a heavy machine is the same as that in FIGS. 1 to 3. A different point is a method of gripping a utility pole. In FIG. 2, the middle of the utility pole is lifted by using a rope, and thus, when the balance of the utility pole is lost, the utility pole starts swinging. On the other hand, the proposed method is illustrated in FIG. 5. A utility pole is gripped in such a manner that the circumference of the utility pole is surrounded. FIG. 6 illustrates a gripping portion. Due to sufficient power to lift a utility pole, the utility pole can be lifted without swinging. Thus, the utility pole can be put (backfilled) into a hole opened in the ground without swinging. Thus, the number of workers can be reduced.

### CITATION LIST

### Patent Literature

PTL 1: JP 2700566 B

### SUMMARY OF THE INVENTION

### Technical Problem

However, a utility pole has a direction, the direction cannot be ignored to perform backfilling. An orientation of a utility pole is illustrated from FIGS. 7 to 10. FIG. 7 illustrates that the utility pole 121 has a hole for a scaffold bolt. FIG. 8 illustrates a bar that is referred to as a scaffold bolt 131. FIG. 9 illustrates a drawing of a state in which this scaffold bolt 131 is put into the hole of the utility pole 121 and is fixed. As illustrated in FIG. 9, a plurality of scaffold bolts 131 are fixed to one utility pole 121. A worker put his or her feet on the scaffold bolts 131 to climb the utility pole 121.

A direction in which the scaffold bolts can be installed has a rule and the rule is illustrated in FIG. 10. A rule that scaffold bolts and a cable are installed so as to be parallel to a road is imposed. Currently, a worker performs manual and fine adjustment and alignment in a state where the utility pole is being lifted with a crane. Thus, the worker performs manual alignment, and thus, the worker needs to be assigned for the work.

In the related art, the number of workers for stopping swinging of the utility pole can be reduced as described above. However, because of no function of rotating the utility pole when the utility pole is gripped, the utility pole cannot be rotated, and orientations of the scaffold bolts (an orientation of the side surface of the utility pole) cannot be adjusted.

In order to solve the problem described above, an object of the present invention is to provide a utility pole rotation apparatus and a position control method that can reduce the number of workers to be required for adjusting the orientation of the side surface of the utility pole in addition to reduction of the number of workers for stopping swinging of the utility pole.

### Means for Solving the Problem

In order to achieve the above-described object, the utility pole rotation apparatus of the present disclosure is configured in such a manner that a roller capable of contacting a utility pole and rotating the utility pole is attached to a gripping portion capable of stopping swinging of the utility pole.

Specifically, a utility pole rotation apparatus according to the present disclosure includes a gripping portion configured to grip a utility pole, and a roller having a cylindrical shape, configured to contact the utility pole at an inner side of the gripping portion, and configured to rotate the utility pole with a longitudinal direction serving as an axis due to rotation of the roller.

A position control method according to the present disclosure includes gripping a utility pole in such a manner that a gripping portion surrounds a side surface of the utility pole and a longitudinal direction of the utility pole is perpendicular to a ground surface, bringing a roller having a cylindrical shape and being attached to the grip portion into contact with the utility pole at an inner side of the gripping portion, and rotating the utility pole with the longitudinal direction serving as an axis due to rotation of the roller.

The utility pole rotation apparatus according to the present disclosure is configured in such a manner that the roller capable of contacting a utility pole and rotating the utility pole is attached to the gripping portion capable of stopping swinging of the utility pole, and thus, the utility pole rotation apparatus can grip and rotate the utility pole without swinging the utility pole. As a result, it is possible to provide the utility pole rotation apparatus and the position control method that can reduce the number of workers to be required for adjusting the orientation of the side surface of the utility pole in addition to reduction of the number of workers for stopping swinging of the utility pole.

The utility pole rotation apparatus according to the present disclosure further includes a sensor fixed at a position separated from a side surface of the utility pole in a radial direction of the utility pole by a predetermined distance and configured to capture a target object on a ground surface to detect that the side surface of the utility pole is in a desired orientation due to the rotation with the longitudinal direction of the utility pole serving as the axis.

For example, in the utility pole rotation apparatus according to the present disclosure, the sensor may generate a sound or an optical signal to indicate a fact that the side surface of the utility pole is in the desired orientation.

The position control method according to the present disclosure further includes capturing a target object on a ground surface and detecting that the side surface of the utility pole is in a desired orientation when the utility pole is rotated, and stopping the rotating of the utility pole when the target object is detected.

For example, the position control method according to the present disclosure may generate a sound or an optical signal to indicate that the side surface of the utility pole is in the desired orientation when the target object is detected.

The utility pole rotation apparatus can more easily adjust the orientation of the side surface of the utility pole by including the sensor.

Note that each of the inventions described above can be combined with the others to the extent possible.

### Effects of the Invention

According to the present disclosure, it is possible to provide a utility pole rotation apparatus and a position control method that can reduce the number of workers to be required for adjusting the orientation of the side surface of the utility pole in addition to the reduction of the number of workers for stopping swinging of the utility pole.

### BRIEF DESCRIPTION OF DRAWINGS

FIG. 1 illustrates an example of a conventional utility pole installation method.

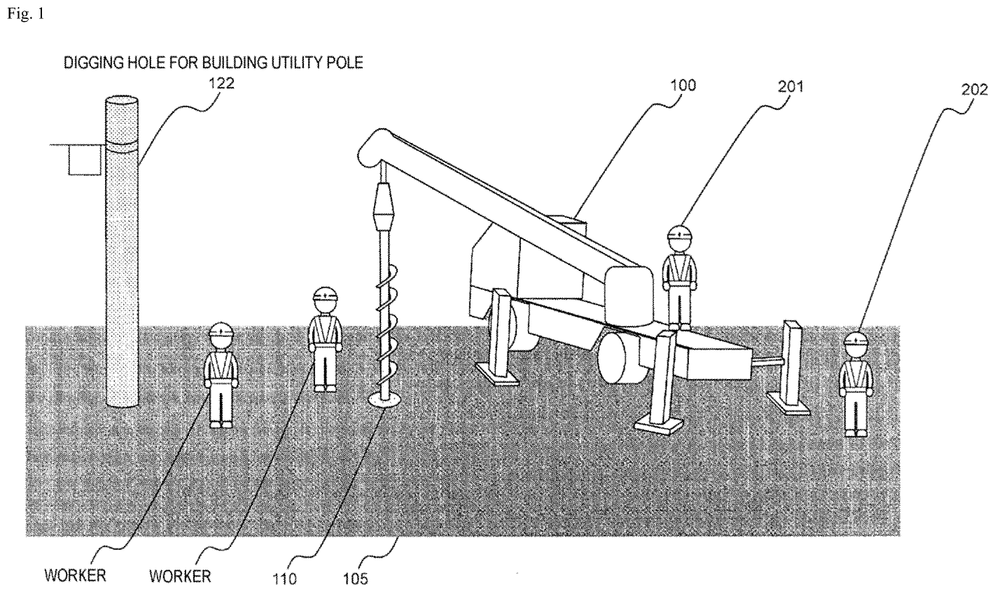

FIG. 2 illustrates an example of the conventional utility pole installation method.

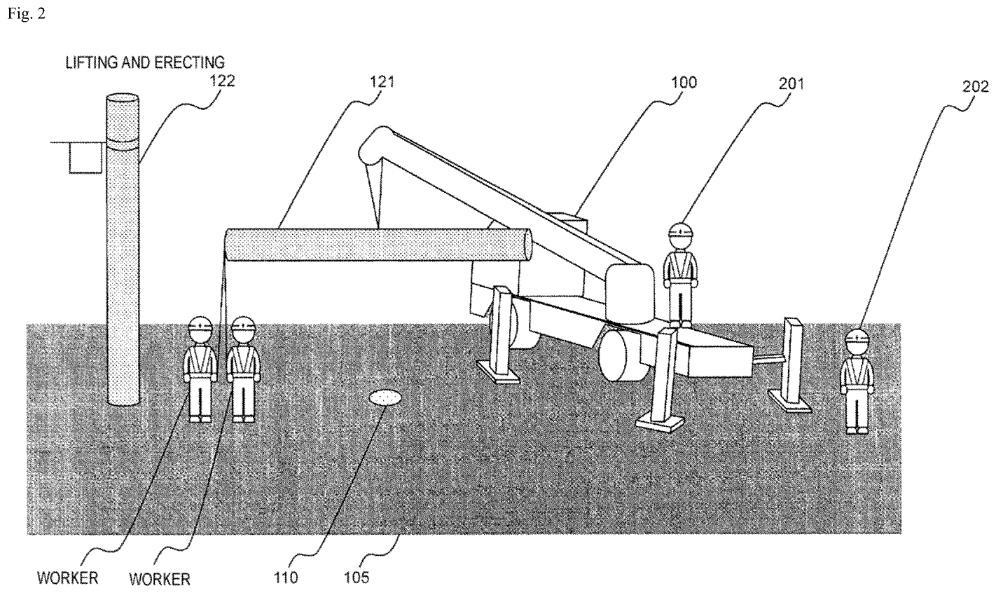

FIG. 3 illustrates an example of the conventional utility pole installation method.

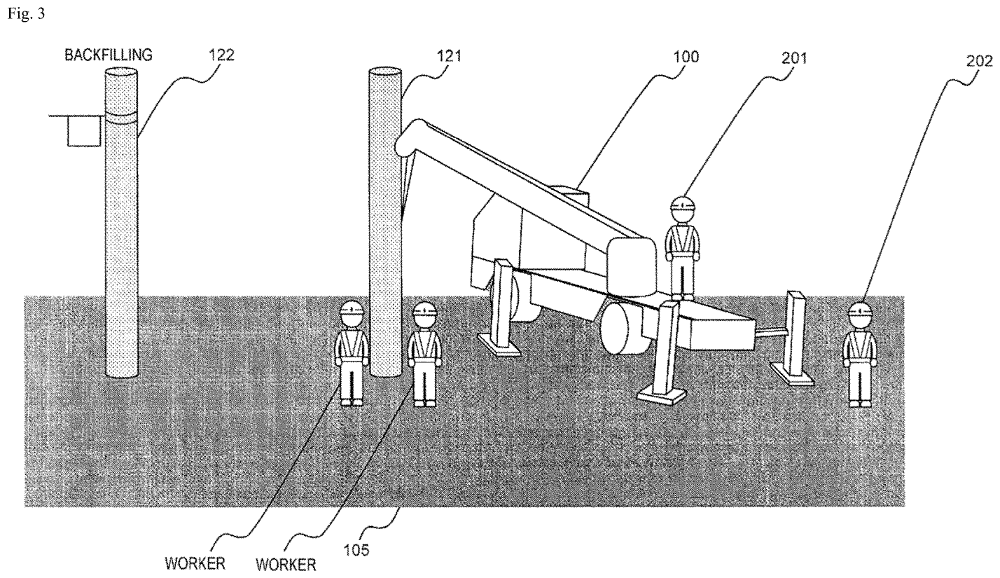

FIG. 4 illustrates a form of usage of a gripping portion of a utility pole according to a related art.

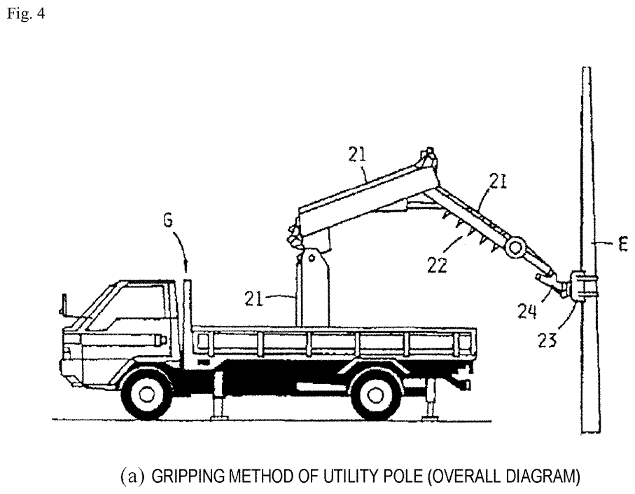

FIG. 5 illustrates a schematic configuration and a form of usage of the gripping portion of a utility pole according to the related art.

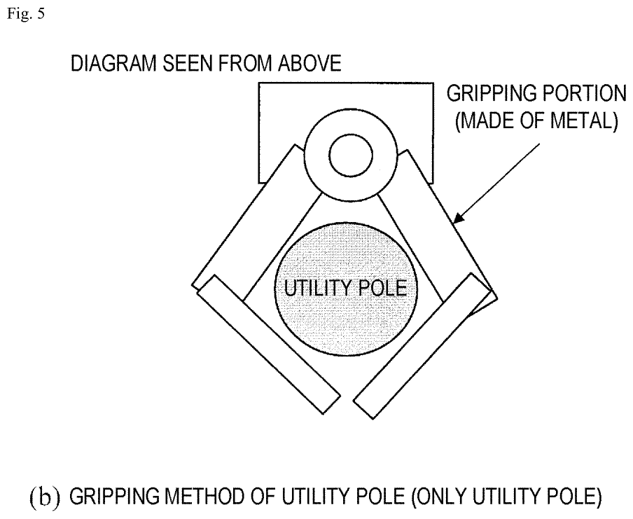

FIG. 6 illustrates a schematic configuration of the gripping portion of a utility pole according to the related art.

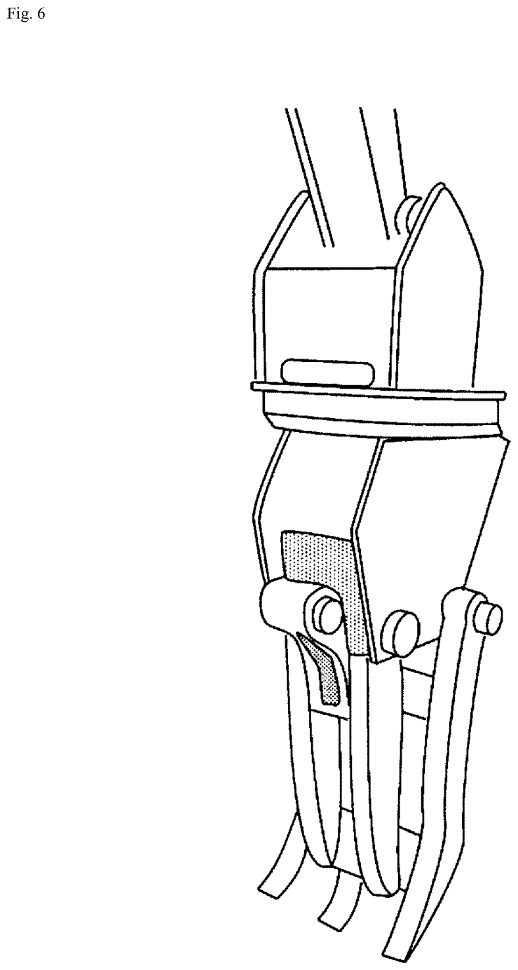

FIG. 7 illustrates an example of a hole for a scaffold bolt of a utility pole.

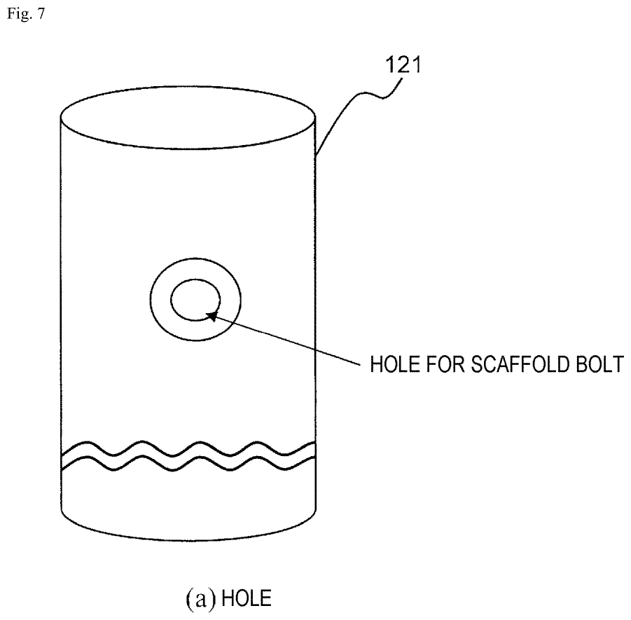

FIG. 8 illustrates an example of a state in which a scaffold bolt is fixed to the utility pole.

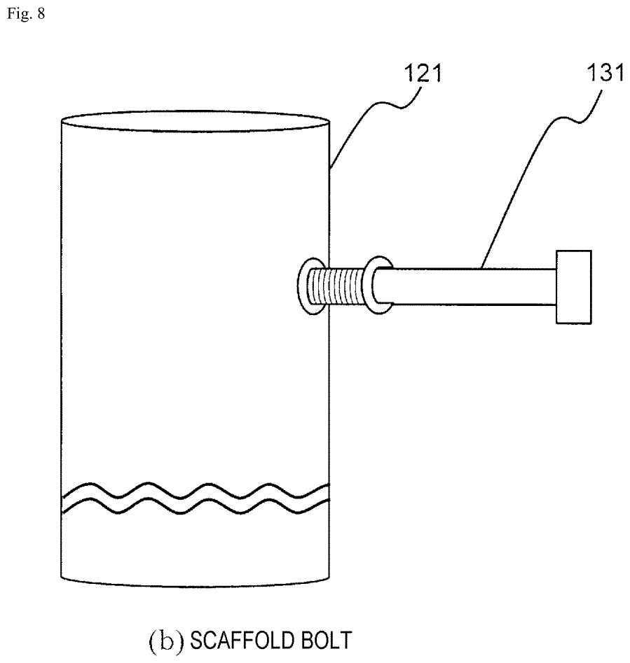

FIG. 9 illustrates an example of a schematic configuration of a utility pole which scaffold bolts are fixed with.

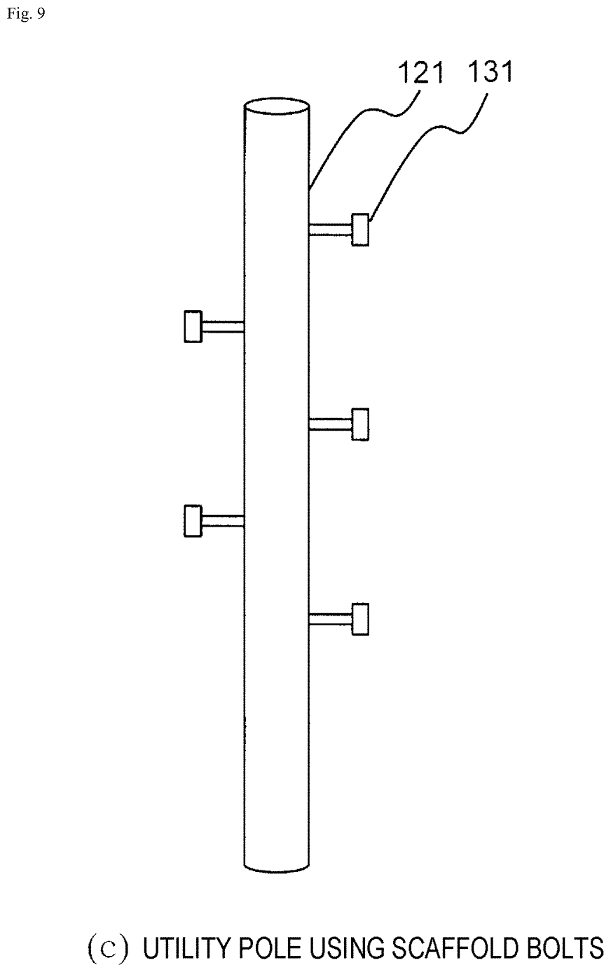

FIG. 10 illustrates a rule for the installation of scaffold bolts.

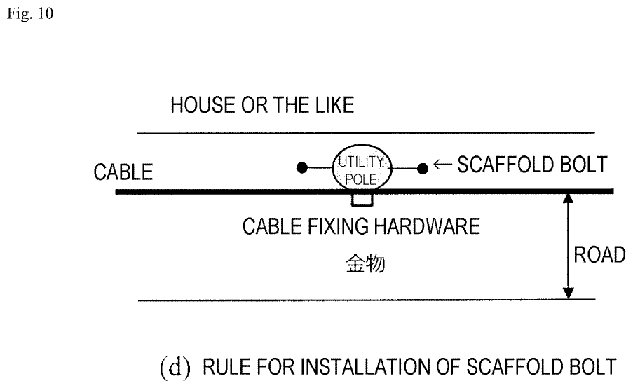

FIG. 11 illustrates an example of a form of usage of a utility pole rotation apparatus according to the present invention.

FIG. 12 illustrates an example of a form of usage of the utility pole rotation apparatus according to the present invention.

FIG. 13 illustrates an example of a form of usage of the utility pole rotation apparatus according to the present invention.

FIG. 14 illustrates an example of a schematic configuration and a form of usage of the utility pole rotation apparatus according to the present invention.

FIG. 15 illustrates an example of a schematic configuration and a form of usage of the utility pole rotation apparatus according to the present invention.

FIG. 16 illustrates an example of a schematic configuration and a form of usage of the utility pole rotation apparatus according to the present invention.

FIG. 17 illustrates an example of a procedure of a position control method according to the present invention.

FIG. 18 illustrates an example of a procedure of a position control method according to the present invention.

FIG. 19 illustrates an example of a schematic configuration and a form of usage of a utility pole rotation apparatus according to the present invention.

FIG. 20 illustrates an example of a schematic configuration and a form of usage of the utility pole rotation apparatus according to the present invention.

FIG. 21 illustrates an example of a schematic configuration and a form of usage of the utility pole rotation apparatus according to the present invention.

FIG. 22 illustrates an example of a schematic configuration and a form of usage of the utility pole rotation apparatus according to the present invention.

FIG. 23 illustrates an example of a schematic configuration and a form of usage of the utility pole rotation apparatus according to the present invention.

FIG. 24 illustrates an example of a schematic configuration and a form of usage of the utility pole rotation apparatus according to the present invention.

### DESCRIPTION OF EMBODIMENTS

Hereinafter, embodiments of the present disclosure will be described in detail with reference to the drawings. Note that the present invention is not limited to the embodiments that will be described below. These examples of the embodiments are merely examples, and the present disclosure can be implemented in forms in which various modifications and improvements are added based on knowledge of those skilled in the art. Constituent elements with the same reference signs in the specification and the drawings are assumed to be the same constituent elements.

### First Embodiment

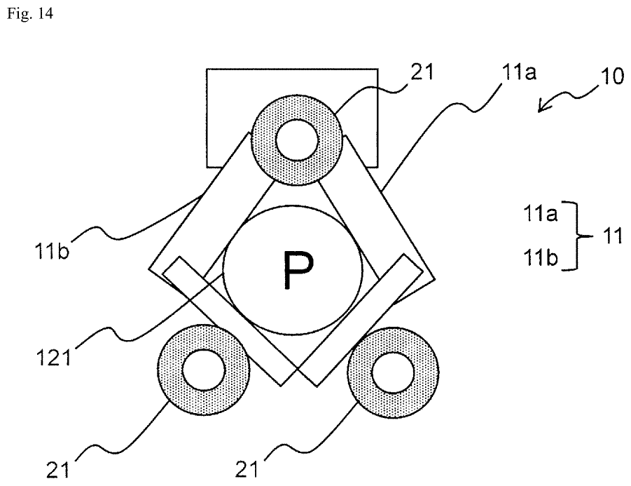

An example of a utility pole rotation apparatus according to the present embodiment is illustrated in FIGS. 14 to 16. The utility pole rotation apparatus 10 includes a gripping portion 11 that grips a utility pole, and a roller 21 that has a cylindrical shape, that contacts a utility pole 121 at an inner side of the gripping portion 11, and that rotates the utility pole 121 with a longitudinal direction serving as an axis due to rotation of the roller.

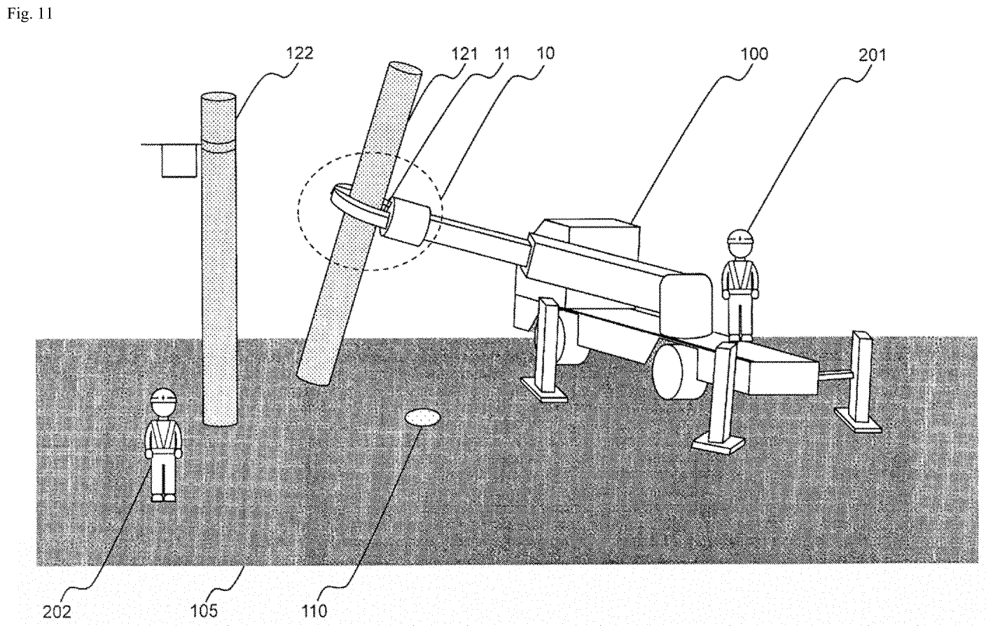

Hereinafter, a configuration and an operation of the utility pole rotation apparatus 10 according to the present embodiment are specifically illustrated by using FIGS. 11 to 16. FIGS. 14 to 16 illustrate a specific configuration of the utility pole rotation apparatus 10. The gripping portion 11 grips the utility pole 121 so as to surround the side surface of the utility pole 121, and stops swinging of the utility pole 121 when gripping the utility pole 121. In the present embodiment, the gripping portion 11 includes two arms 11a and 11b that are bendable, and a control unit (not illustrated) that is connected to the arms 11 a and 11b and that controls the arms 11a and 11b. The control unit causes the gripping portion 11 to grip the utility pole 121 in such a manner that the arms 11a and 11b are perpendicular to the axis in the longitudinal direction of the utility pole 121 and surround the side surface of the utility pole 121.

The roller 21 has a cylindrical shape, and is attached to the gripping portion 11 in such a manner that the roller 21 can contact the utility pole 121 gripped by the gripping portion 11 at the inner side of the gripping portion 11. In addition, the roller 21 is attached to the gripping portion 11 in such a manner that the roller 21 can rotate the utility pole 121 with the longitudinal direction of the utility pole 121 serving as an axis due to rotation of the roller.

In the present embodiment, as illustrated in FIG. 14, the number of the rollers 21 are three. The three rollers 21 are attached to the gripping portion 11 in such a manner that the three rollers 21 can surround the utility pole 121 when contacting the utility pole 121. The contact of the rollers 21 with the utility pole 121 may be caused when the gripping portion 11 grips the utility pole 121, or may be caused by the movement of the rollers 21 after the gripping portion 11 grips the utility pole 121. In addition, the rollers 21 are attached to the gripping portion 11 in such a manner that the axis in the longitudinal direction of the utility pole 121 and rotational axes of the rollers 21 are parallel to each other when contacting the utility pole 121.

When the three rollers 21 contact the utility pole 121, it is preferable that the gripping portion 11 stop contacting the utility pole 121 and support the rollers 21 and thus, the rollers 21 can grip the utility pole 121 while stopping swinging of the utility pole 121 instead of the gripping portion 11.

An example of an operation of the utility pole rotation apparatus 10 is illustrated in FIGS. 11 to 16. FIGS. 11 to 13 illustrate an operation in which the utility pole 121 is put into the hole 110 by the utility pole rotation apparatus 10 included in the crane vehicle 100. Further, FIGS. 14 to 16 illustrate an operation of rotating the utility pole 121 by using the gripping portion 11.

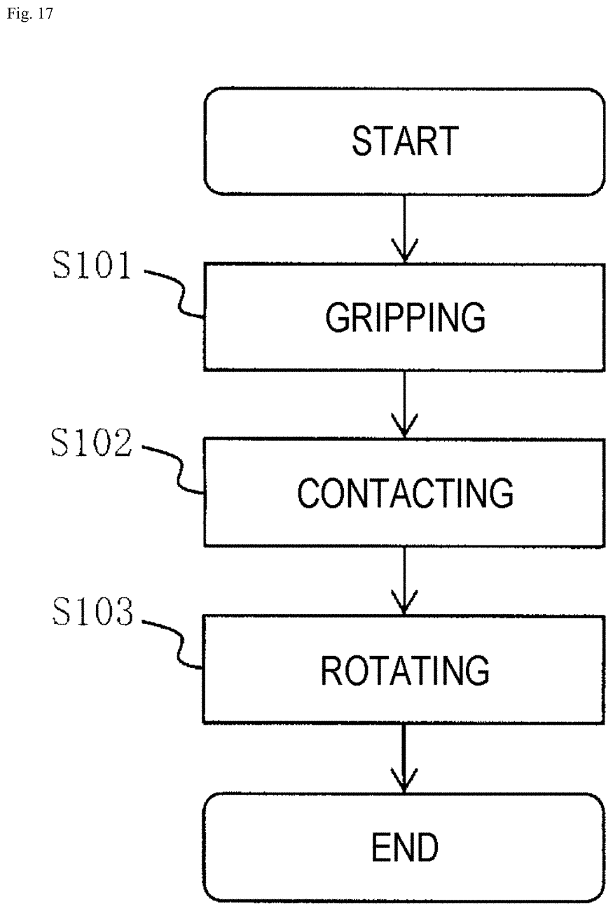

A flowchart of a position control method according to the present embodiment is illustrated in FIG. 17. The position control method according to the present embodiment performs a gripping step S101 of gripping the utility pole 121 in such a manner that the gripping portion 11 surrounds the side surface of the utility pole 121 and the longitudinal direction of the utility pole 121 is perpendicular to the ground surface 105, a contacting step S102 where the rollers 21 having a cylindrical shape and being attached to the gripping portion 11 contact the utility pole 121 at the inner side of the gripping portion 11, and a rotating step S103 of rotating the utility pole 121 with the longitudinal direction serving as an axis due to rotation of the rollers 21. Hereinafter, the steps S101 to S103 will be described in detail.

### Step S101

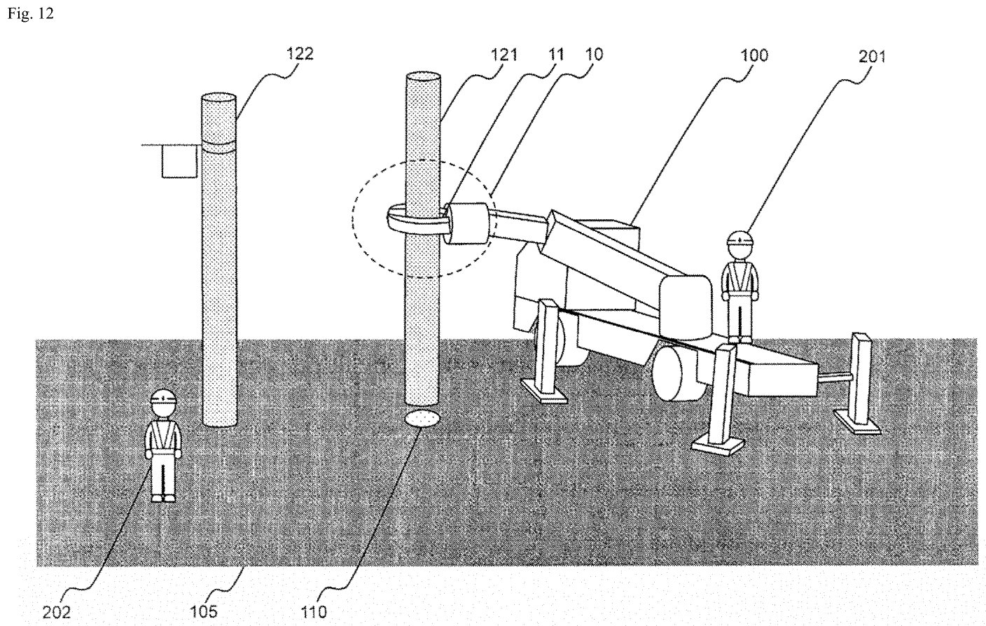

FIGS. 11, 12, and 14 illustrate a state of the gripping step S101. As illustrated in FIGS. 11 and 12, in the gripping step, the utility pole 121 is gripped in such a manner that the gripping portion 11 surrounds the side surface of the utility pole 121 and the longitudinal direction of the utility pole 121 is perpendicular to the ground surface 105. In the present embodiment, while the gripping portion 11 grips the utility pole in such a manner that the arms 11a and 11b are perpendicular to the axis of the longitudinal direction of the utility pole 121 and surround the side surface of the utility pole 121, the utility pole 121 is erected by using the crane vehicle 100 in such a manner that the axis in the longitudinal direction of the utility pole 121 is perpendicular to the ground surface 105. At this time, the utility pole rotation apparatus 10 does not put the utility pole 121 into the hole 110. Further, as illustrated in FIG. 14, in the gripping step S101, the rollers 21 and the utility pole 121 are not in contact with each other, but the gripping portion 11 contacts the utility pole 121, thereby gripping the utility pole 121.

### Step S102

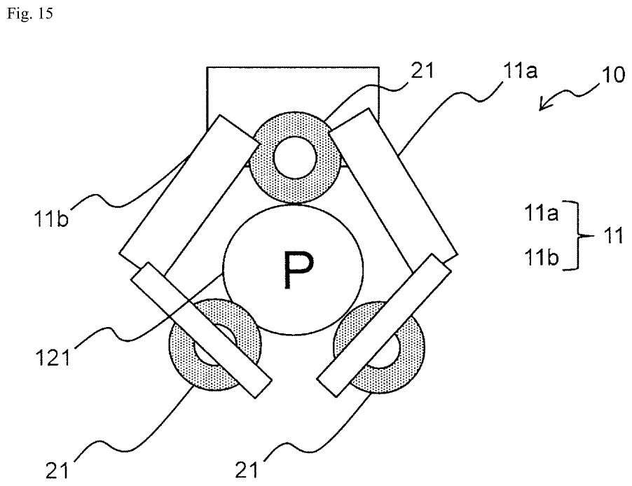

A state of the contacting step S102 is illustrated in FIG. 15. In the contacting step S102, the rollers 21 having a cylindrical shape and being attached to the gripping portion 11 are brought into contact with the utility pole 121 at the inner side of the gripping portion 11. In the present embodiment, the rollers 21 are moved and brought into contact with the utility pole 121.

### Step S103

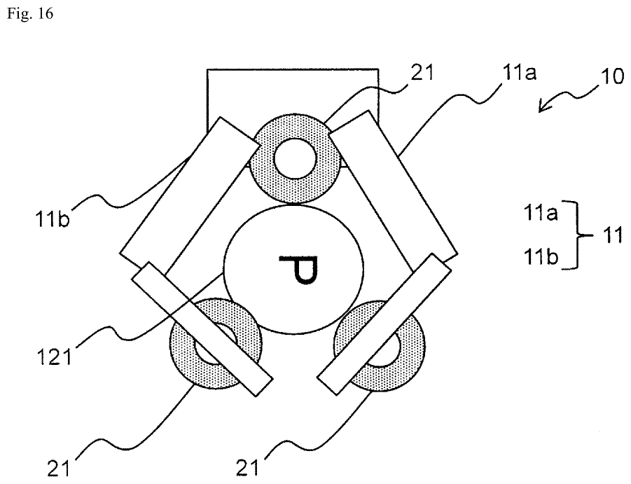

In the rotating step S103, the utility pole 121 is rotated with the longitudinal direction thereof serving as the axis due to rotation of the rollers 21. FIG. 15 illustrates a state before the rotation and FIG. 16 illustrates a state after the clockwise rotation by 90°. In this way, by applying a plurality of rollers 21 at the tip of the gripping portion 11, the utility pole 121 can be rotated in a circumferential direction.

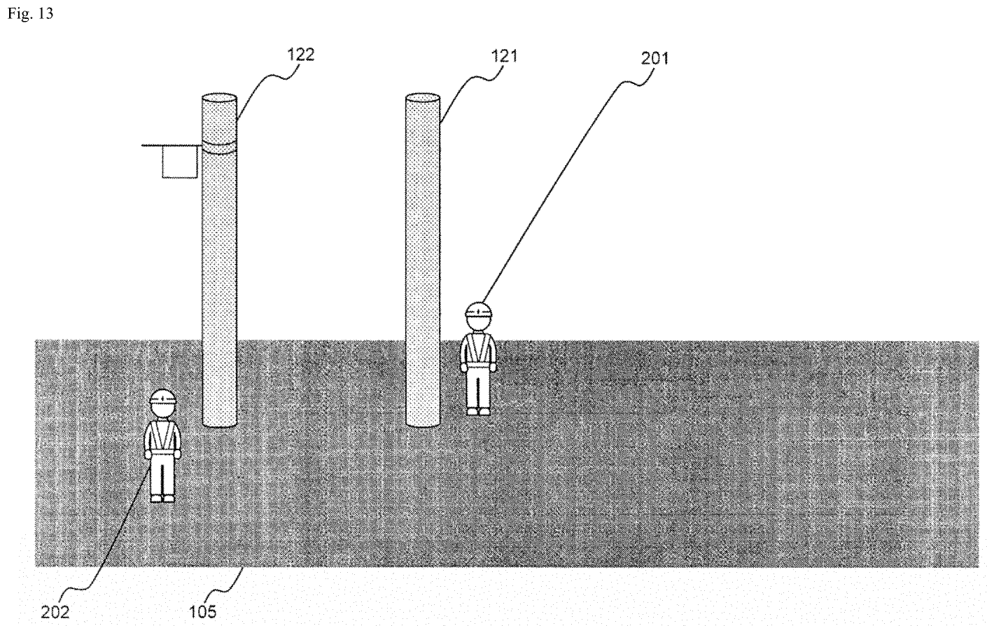

The utility pole rotation apparatus 10 rotates the side surface of the utility pole 121 by using the rollers 21 to the desired orientation, then, puts the utility pole 121 to the bottom of the hole 110, and separates the utility pole 121 from the gripping portion 11 as illustrated in FIG. 13.

As described above, stopping swinging of the utility pole 121 and adjusting the orientation of the side surface of the utility pole 121 can be performed by the utility pole rotation apparatus 10, and thus, workers to be required in the inventions according to the present embodiment are only one heavy machine operator 201 and a guard (guide worker) 202 for ensuring safety of pedestrians. Thus, by attaching the rollers 21 that can contact the utility pole 121 to the gripping portion 11 capable of stopping swinging of the utility pole 121, it is possible to provide the utility pole rotation apparatus and the position control method that can reduce not only the number of workers for stopping swinging of the utility pole 121 but also the number of workers required for adjusting the orientation of the side surface of the utility pole 121. Note that the number of rollers 21 is not limited to three. The number of rollers 21 changes depending on the number of arms of the gripping portion 11.

### Second Embodiment

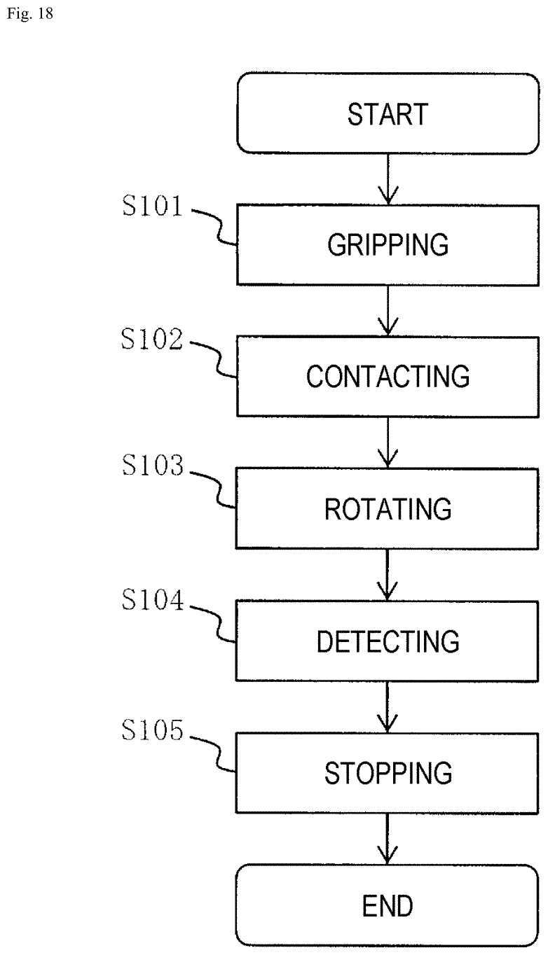

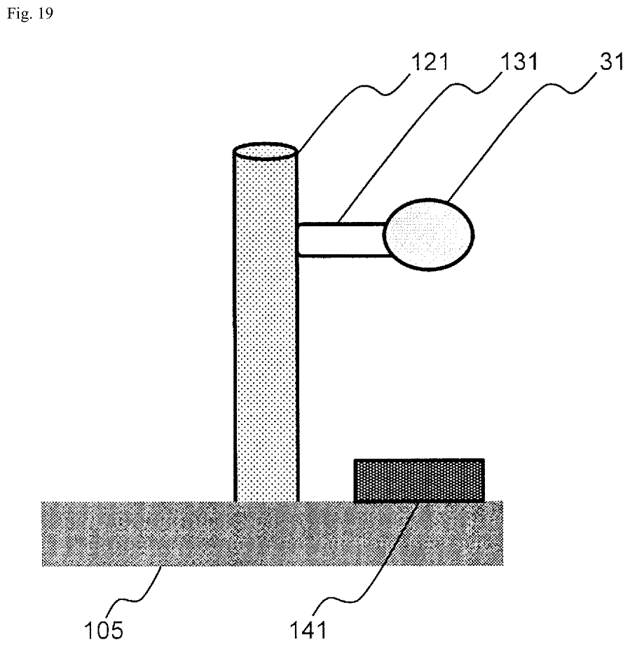

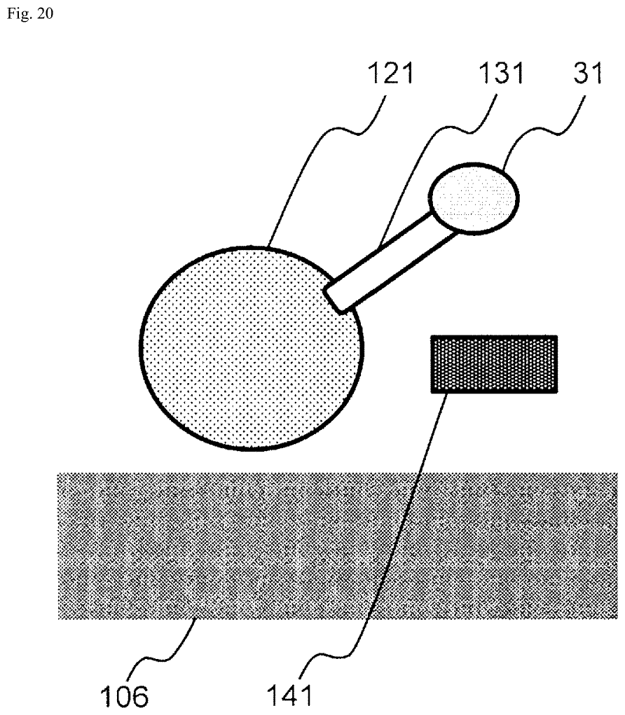

Hereinafter, a configuration and an operation of the utility pole rotation apparatus 10 according to the present embodiment are specifically illustrated by using FIGS. 18 to 24. FIGS. 19 to 24 illustrate a state where the utility pole 121 is erected perpendicular to the ground surface 105 directly above the hole 110 immediately before the lower bottom surface of the utility pole 121 is put into the hole 110. That is, the state refers to the state illustrated in FIG. 12. FIGS. 19, 23, and 24 are diagrams in which the utility pole 121 is viewed from the side. FIGS. 20 to 22 are diagrams in which the utility pole 121 is viewed from the above. The utility pole rotation apparatus 10 according to the present embodiment is added with a function of detecting a desired orientation of the side surface of the utility pole 121 to the utility pole rotation apparatus 10 according to the first embodiment. The function will be described below.

The utility pole rotation apparatus 10 further includes a sensor 31 that is fixed at a position separated from the side surface of the utility pole 121 by a predetermined distance in the radial direction of the utility pole 121 and that is configured to capture a target object on the ground surface 105 to detect that the side surface of the utility pole 121 is in the desired orientation due to rotation with the longitudinal direction of the utility pole 121 serving as the axis.

In the present embodiment, as illustrated in FIG. 19, the scaffold bolt 131 is fixed perpendicular to the side surface of the utility pole 121. The scaffold bolt 131 includes a scaffold portion having a length of a degree that a person climbing the utility pole 121 can place his or her foot in the radial direction of the utility pole 121 and a tip portion that is a tip of the scaffold portion. The sensor 31 is fixed to the tip portion of the scaffold bolt 131.

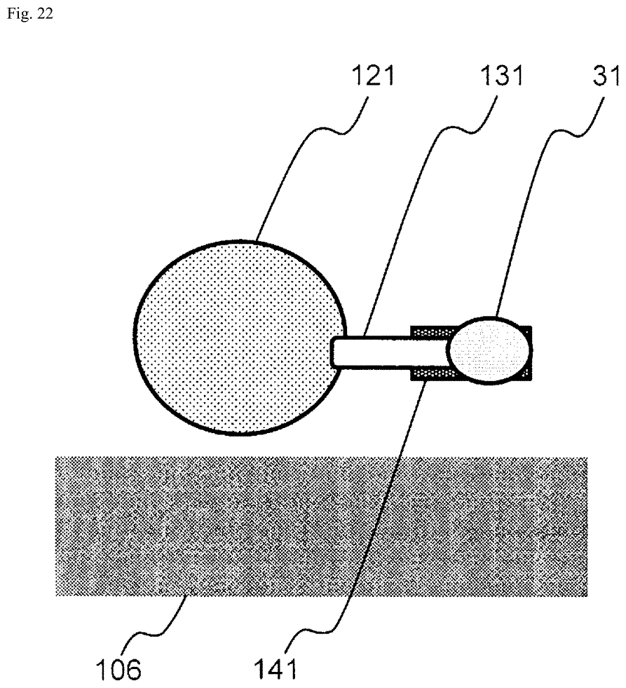

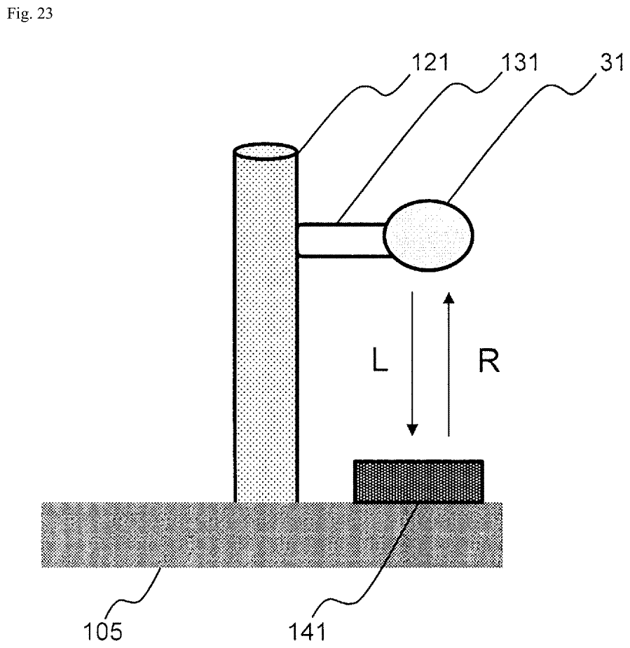

As illustrated in FIG. 23, the sensor 31 vertically emits light (L) toward the ground surface 105 and determines whether the target object is captured by measuring an intensity of the reflected light (R). In the present embodiment, the target object is determined to be a line 141. The line 141 is on the ground surface 105 and has higher reflectivity of the light (L) than that of the ground surface 105. When viewed from directly above the hole 110 into which the utility pole 121 is put, the line 141 is drawn so as to be parallel to the radial direction of the hole 110 and the road 106 and so as to pass through at least a position separated from the hole 110 by the length of the scaffold portion of the scaffold bolt 131 previously described (FIG. 20). The light (L) emitted by the sensor 31 may be strongly reflected only from the line 141. As illustrated in FIG. 22, when the sensor 31 is positioned directly above the line 141, the sensor 31 intensively senses the reflected light (R) and detects that the line 141 being the target object is captured.

The sensor 31 notifies the heavy machine operator 201 of the detection when capturing and detecting the line 141 being the target object. For example, the sensor 31 may generate a sound or an optical signal to indicate that the side surface of the utility pole 121 is in the desired orientation. In the present embodiment, when the sensor 31 is positioned directly above the line 141, the side surface of the utility pole 121 is determined to be in the desired orientation.

A flowchart of a position control method according to the present embodiment is illustrated in FIG. 18. The position control method according to the present embodiment is based on the position control method according to the first embodiment (from S101 to S103) and further performs a detecting step S104 of capturing the line 141 being a target object on the ground surface 105 and detecting that the side surface of the utility pole 121 is in a desired orientation when the utility pole 121 is rotated and a stopping step S105 of stopping rotating the utility pole 121 when the line 141 is detected. Steps S101 to S103 are similar to those of the first embodiment. Hereinafter, operations of the step S103 and the newly added steps S104 and S105 according to the present embodiment will be described in detail.

### Step S103

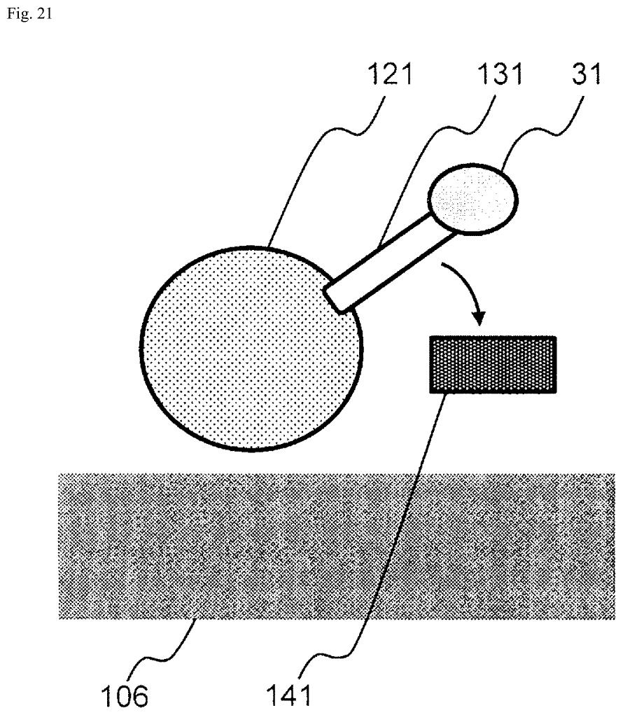

FIG. 20 illustrates a state before the utility pole rotation apparatus 10 rotates the utility pole 121. FIG. 21 illustrates a state in which the utility pole rotation apparatus 10 rotates the utility pole 121 so that the sensor 31 is positioned directly above the line 141 in the step S103. When the sensor 31 is not positioned directly above the line 141, an intensity of the reflected light (R) measured by the sensor 31 is low and the target object is not detected. The utility pole rotation apparatus 10 continues to rotate the utility pole 121 until the target object is detected by the sensor 31.

### Step S104

Due to the rotation of the utility pole 121 in the step S103, the sensor 31 captures the line 141 being the target object on the ground surface 105 and detects that the side surface of the utility pole 121 is in the desired orientation. In the present embodiment, as described above, when the sensor 31 is positioned directly above the line 141, the side surface of the utility pole 121 is determined to be in the desired orientation. When the sensor 31 is positioned directly above the line 141 (FIG. 22), the sensor 31 intensively senses the reflected light (R) and detects that the line 141 being the target object is captured (FIG. 23).

The sensor 31 notifies the heavy machine operator 201 of the detection when capturing and detecting the line 141 being the target object. For example, when detecting the line 141 being the target object, the sensor 31 may generate a sound or an optical signal to indicate that the side surface of the utility pole 121 is in the desired orientation.

### Step S105

The utility pole rotation apparatus 10 stops rotating the utility pole 121 when the sensor 31 detects the line 141 being the target object.

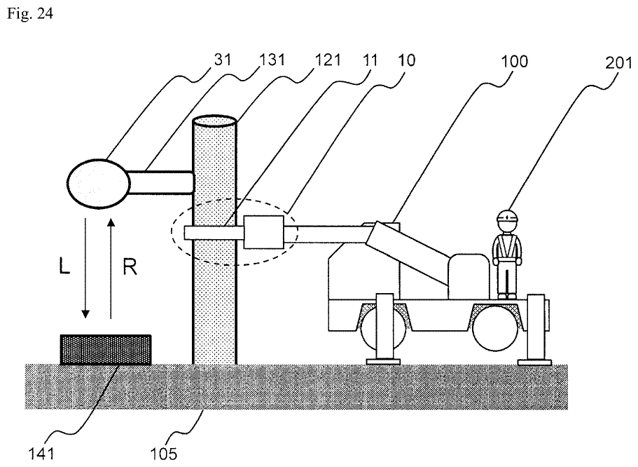

As illustrated in FIG. 24, the inventions according to the present embodiment enable the heavy machine operator 201 to accurately and easily recognize the orientation of the utility pole 121 even in a case where the heavy machine operator 201 cannot precisely check a rotational angle of the utility pole 121 because of a long distance between a position where the heavy machine operator 201 operates a heavy machine and an installation position of the utility pole 121.

As described above, by including the sensor 31, the utility pole rotation apparatus 10 can more easily adjust the orientation of the side surface of the utility pole 121.

Note that each of the inventions described above can be combined with the others to the extent possible.

### REFERENCE SIGNS LIST

10: Utility pole rotation apparatus
11: Gripping portion
11a, 11b: Arm
21: Roller
31: Sensor
100: Crane vehicle
105: Ground surface
106: Road
110: Hole
121, 122: Utility pole
131: Scaffold bolt
141: Line
201: Heavy machine operator
202: Guide worker

1. A utility pole rotation apparatus comprising:
a gripping portion configured to grip a utility pole; and
a roller having a cylindrical shape, the roller being configured to contact the utility pole at an inner side of the gripping portion, the roller being configured to rotate the utility pole with a longitudinal direction serving as an axis due to rotation of the roller.

2. The utility pole rotation apparatus according to claim 1, further comprising:
a sensor fixed at a position separated from a side surface of the utility pole in a radial direction of the utility pole by a predetermined distance, the sensor being configured to capture a target object on a ground surface to detect that the side surface of the utility pole is in a desired orientation due to the rotation with the longitudinal direction of the utility pole serving as the axis.

3. The utility pole rotation apparatus according to claim 2, wherein
the sensor generates a sound or an optical signal to indicate that the side surface of the utility pole is in the desired orientation.

4. A position control method comprising:
gripping a utility pole in such a manner that a gripping portion surrounds a side surface of the utility pole and a longitudinal direction of the utility pole is perpendicular to a ground surface;
bringing a roller having a cylindrical shape into contact with the utility pole at an inner side of the gripping portion, the roller being attached to the gripping portion; and
rotating the utility pole with the longitudinal direction serving as an axis due to rotation of the roller.

5. The position control method according to claim 4, further comprising:
capturing a target object on a ground surface and detecting that the side surface of the utility pole is in a desired orientation when the utility pole is rotated; and
stopping the rotating of the utility pole when the target object is detected.

6. The position control method according to claim 5, wherein, when the target object is detected, a sound or an optical signal is generated to indicate that the side surface of the utility pole is in the desired orientation.
